(19) United States
(12) Patent Application Publication
(10) Pub. No.: US 2005/0133304 A1
(43) Pub. Date: Jun. 23, 2005

(54) Fluid exchange system for vehicles

(76) Inventor: James P. Viken, Eden Prairie, MN (US)

Correspondence Address: John F. Klos, Esq.;Fulbright & Jaworski L.L.P., Suite 2100, 80 South Eighth Street, Minneapolis, MN, 55402-4320, US

(21) Appl. No.: 10/925,695

(22) Filed: Aug. 24, 2004

Related U.S. Application Data
(63) Continuation-in-part of application No. 10/026,137, filed on Dec. 18, 2001, now Pat. No. 6,779,633.
Application No. 10/026,137 is a continuation of application No. 08/772,836, filed on Dec. 24, 1996, now Pat. No. 6,330,934.
Application No. 08/772,836 is a continuation of application No. 08/469,673, filed on Jun. 6, 1995, now abandoned.
Application No. 08/469,673 is a continuation-in-part of application No. 08/209,061, filed on Mar. 9, 1994, now Pat. No. 5,472,064.
Application No. 08/209,061 is a continuation-in-part of application No. 07/781,322, filed on Oct. 23, 1991, now Pat. No. 5,318,080.

(51) Int. Cl. F16C 3/14

(52) U.S. Cl. 184/1.5

(57) ABSTRACT

A system for changing the fluid of vehicular automatic transmissions and power steering systems. The fluid exchange procedure of the present invention may include a bypass mode of operations whereby fluid from the vehicle is recirculated. The bypass mode of operations may take place before, during or after the exchange of used fluid with fresh fluid. The exchange system may also incorporate a flow alignment valve assembly whereby the operator may quickly and efficiently correct for a misconnection of the hoses into the accessed automatic transmission system or power steering system.

### RELATED APPLICATIONS

This application is a continuation-in-part of application Ser. No. 10/026,137, filed Dec. 18, 2001, now U.S. Pat. No. 6,667,633, which was a continuation of application Ser. No. 08/772,836, filed Dec. 24, 1996, now U.S. Pat. No. 6,330,934, which was a continuation of application Ser. No. 08/469,673, filed Jun. 6, 1995, and which was a continuation-in-part of application Ser. No. 08/209,061 filed Mar. 9, 1994, granted U.S. Pat. No. 5,472,064, and now U.S. Reissue Pat. No. RE36,650, which was a continuation-in-part of application Ser. No. 07/781,322 filed Oct. 23, 1991, now U.S. Pat. No. 5,318,080, each related application being incorporated by reference herein.

### FIELD OF THE INVENTION

This invention relates generally to changing the fluid of vehicular automatic transmissions and/or power steering circuits and more specifically to a fluid exchange system providing bypass flow and/or flow alignment capabilities.

### SUMMARY OF THE INVENTION

A fluid exchange system having a first fluid line selectively intercoupled to the fluid exchange system and one of a pair of fluid circuit ports to conduct fluid from a fluid circuit of a vehicle and a second fluid line selectively intercoupled to the fluid exchange system, a source of fresh fluid, and the other one of the pair of fluid circuit ports to conduct fluid into the fluid circuit of the vehicle. The fluid exchange system also includes a bypass fluid path and a bypass valve assembly in communication with the bypass fluid path, said fluid exchange system having a pair of operational conditions including: a first operational condition wherein used fluid is passed through the bypass fluid path and reintroduced into the fluid circuit of the vehicle, and a second operational condition wherein used fluid is received into the first fluid line and fresh fluid is received into the second fluid line and introduced into the fluid circuit of the vehicle. The bypass valve may be actuated via mechanical, electromechanical, or hydraulic means. The fluid exchange system can be used to service both automatic transmission systems and power steering systems.

### DESCRIPTION OF THE DRAWINGS

FIG. 1 is a representative illustration of the applicant's system as it is typically positioned with respect to a vehicle being serviced.

FIG. 2 is a schematic illustration an embodiment interconnected to a vehicular automatic transmission to be serviced by the invention.

FIG. 3 is a schematic illustration an embodiment interconnected to a vehicular automatic transmission or power steering system to be serviced by the invention.

FIGS. 4 and 5 are schematic illustrations a power steering circuit of a vehicle to be serviced by the invention.

### DETAILED DESCRIPTION OF A PREFERRED EMBODIMENT OF THE INVENTION

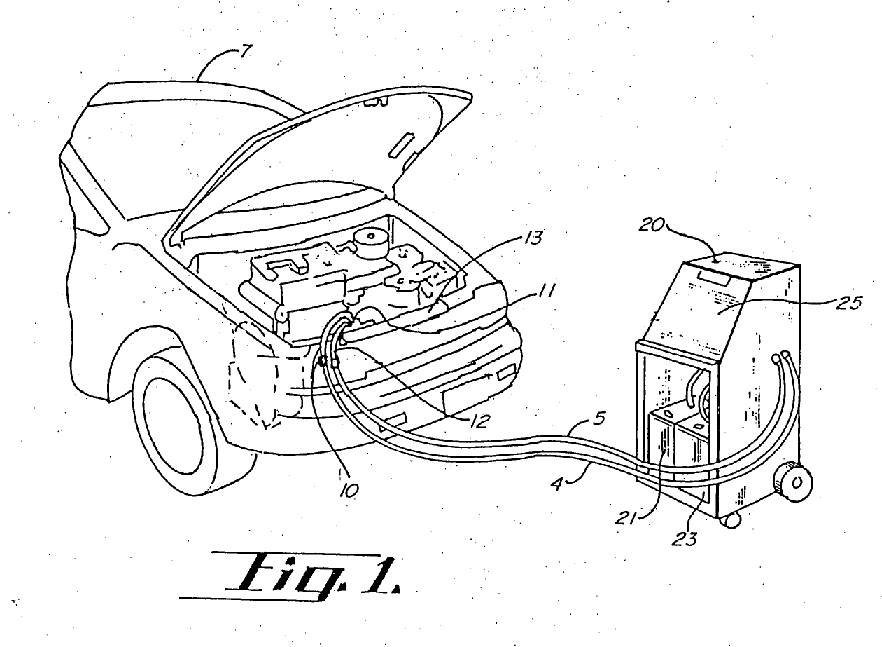

FIG. 1 is a representative illustration of a fluid exchange system 20 as it may be positioned relative to a vehicle 7 being serviced. Fluid exchange system 20 is interconnected into the automatic transmission system via a pair of interchangeable input/output hoses (an input/output hose 4 and an input/output hose 5) to vehicle 7 being service.

In the illustrated embodiment of FIG. 1, hoses 4 and 5 are connected to an accessed transmission cooling circuit of vehicle 7 which connects to and runs through a transmission cooler 11 which may be an integral part of a radiator 13. Hose 4, 5 connection may be done by making random connection to a pair of quick connect stems (a quick connect stem 10 and a quick connect stem 12) which have been interconnected to the cooling circuit. A used fluid receptacle 21 is used to receive the used fluid extracted from transmission 9 by the fluid exchanger 20. A fresh fluid receptacle 23 is used to supply the fresh fluid which is introduced into transmission 9 during an exchange mode of operation. A control panel 25 is located on the fluid exchange system 20 to provide indications of operation and/or control.

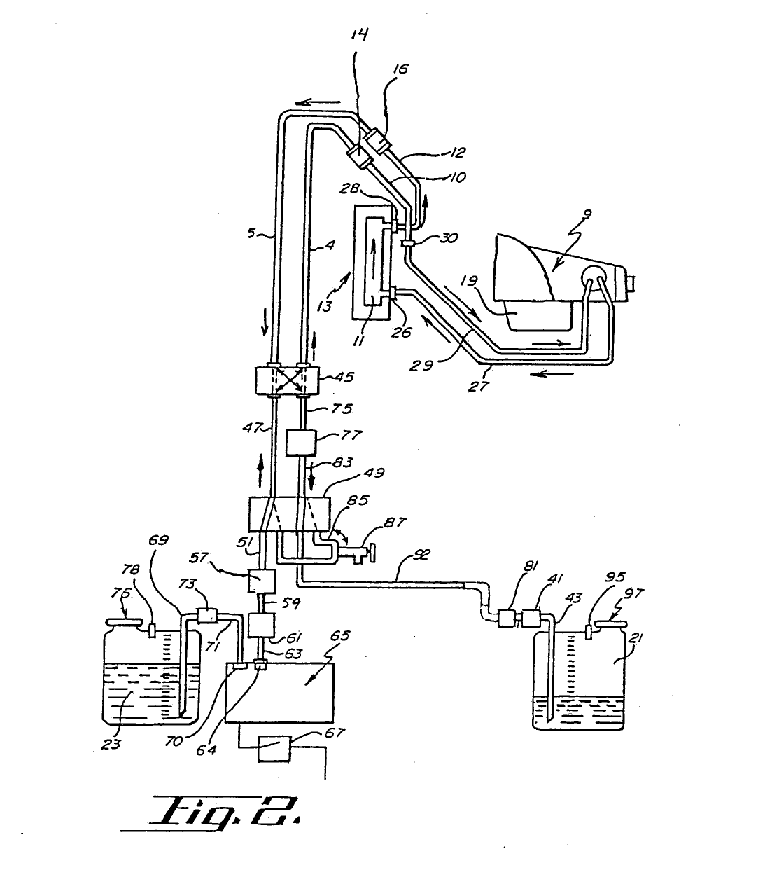

FIG. 2 is an illustration of a first embodiment of the fluid exchange system 20 which is randomly interconnected to both sides of an opened fluid cooling circuit 27/11/29, designated as 27/11/29 because before being opened it is comprised of a cooling outlet line 27, a transmission fluid cooler 11 inside a radiator 13 and a cooling return line 29, each of which form together a connected, complete cooling circuit of transmission 9. Input/output hoses 4, 5 are shown interconnected to both sides of cooling circuit 27/11/29. Hose 4 is connected to line 29 at connector 30, through stem 10 which is connected to hose 4 by quick connector 14. Stem 10 is connected to the end of line 29 at connector 30 after connector 30 has been disconnected from a port 28 of cooler 11 (as an alternative choice, a port 26 of cooler 11 can be disconnected for the interconnection location if preferred by the operator). Hose 5 is connected to line 27 through stem 12 which is connected to hose 5 by quick connector 16 which is connected to opened port 28 of cooler 11, thereby connecting hose 5 to a transmission cooler 11 located in radiator 13. Input/output hoses 4 and 5 are connected to two different ports of a flow alignment valve 45. Valve 45 may be a manually and/or electrically actuated valve or valves. Valve 45 may be a 4 port, two position, electrically actuated fluid valve as illustrated in FIG. 2.

Used fluid receptacle 21 has an opening with a closure 97 and a vent tube 95. Receptacle 21 has volume level indicating marks numbered in quarts (not shown). A used fluid delivery line 92 connects one port of a bypass valve 49 to an used fluid receptacle 21. Bypass valve 49 in one embodiment is a combination, multi-port, two-position flow direction selector valve. Bypass valve 49 may comprise a plurality of valves, passages and/or conduits. Bypass valve 49 may be electrically operated, such as via a solenoid. Alternatively, bypass valve 49 may be manually operated, such as by an operator. Additionally, bypass valve 49 may be float-actuated whereby a float within fresh fluid receptacle 23 and/or within used fluid receptacle 21 may be used to control position of bypass valve 49. For example, a float within fresh fluid receptacle 23 may be used to place the exchange system 20 in a bypass mode of operation when the fresh fluid level drops to a predetermined level. The float may be mechanically linked to bypass valve 49 and/or may be electrically coupled to an intermediate electronic controller. Float mechanisms for fluid control are disclosed in applicant's copending application Ser. No. 10/241,734, hereby incorporated by reference in its entirety.

A fluid delivery line 47 connects one port of bypass valve 49 to one port of flow alignment valve 45. Fresh fluid receptacle 23 is connected to a suction tube 69 which is in turn connected by a quick connector 73 to a fresh fluid suction line 71 which is connected to a suction port 70 of a main pump 65. An opening with closure 76 and a vent tube 78 is provided to fresh fluid receptacle 23. Receptacle 23 has volume indicating marks present similar to used fluid receptacle 21, but reversed to illustrate quarts of used fluid deposited (marks not shown).

Main pump 65 can be activated by an electric power supply switch 67, and when activated pumps fresh fluid through an outlet port 64, into a fresh fluid delivery line 63 and through adjustable flow regulator 61. A fresh fluid delivery line 59 connects regulator 61 to a combination rate of flow and total volume of flow indicator/meter 57 which indicates rate of flow and volume of fresh flow delivered. Fresh fluid delivery line 51 connects meter 57 to bypass valve 49. A fluid delivery line 47 connects one port of bypass valve 49 to one port of flow alignment valve 45.

A used fluid delivery line 83 connects one port of bypass valve 49 to a bidirectional combination indicator/meter 77 which indicates direction of used flow, rate of used flow, and total volume of used flow. A used fluid delivery line 75 connects meter 77 to one port of flow alignment valve 45. A three port used fluid bypass fluid path 85 connects two ports of bypass valve 49 with a sample tap 87. Bypass fluid path 85 may comprises a flexible fluid line, a fluid passage-way through a fluid manifold, or other fluid passages as appreciated by those of ordinary skill in the art.

Prior to use of exchange system 20, used fluid receptacle 21 may be emptied through an opening with closure 97 after disconnecting connector 41 and then reconnected to connector 41 so that an empty receptacle is available to receive the used fluid extracted from the transmission 9 being serviced. Fresh fluid receptacle 23 may be filled through an opening in closure 76 while in place, or receptacle 23 can be removed by disconnecting it at connector 73 to fill it, and then replacing it in position and reconnecting connector 73. In heavy duty or fleet applications, it may be useful to connect the invention to receptacles much larger than receptacles 21 and 23, such a bulk containers.

As an example, connection of the system 20 to the transmission system is performed by the following steps. The cooling circuit 27/11/29 is opened at port 28 where line 29 is connected to cooler 11. The operator's selection of the location to open cooling circuit 27/11/29 at port 28 is random and made at the preference of the operator as a matter of ease and convenience. There may be other access locations at which circuit 27/11/29 is suitable for opening, including connection 26, ports at the transmission body, or intermediate connections of the lines defining conduits 27, 29. In such a manner, system 20 may access the hydraulic system of the transmission system of the vehicle 7.

Stem 12 is connected to the outlet side of the opened cooling circuit by connecting it to port 28 of cooler 11 and stem 10 is connected to the inlet side of the opened cooling circuit by connecting it to connector 30 of cooling return line 29. Input/output hoses 4, 5 can be randomly connected to the opened cooling circuit 27/11/29, but in this illustration for sake of example input/output hose 4 is connected to cooling return line 29 through stem 10, and input/output hose 5 is connected to cooling outlet line 27 thought cooler 11 and stem 12.

The fluid exchange system 20 can now be operated. The vehicle is started and run with the transmission in park and the fluid level of pan 19 may be checked and corrected if out of the range desired. In a bypass mode of operation with bypass valve 49 in a bypass condition, used fluid contained in transmission 9 is recirculated through exchange system 20 via conduits 4, 5. In the bypass mode of operation, flow alignment valve 45 may be used to correct the flow of fluid within the bypass valve 45 and conduits 47, 75 relative to the flow of fluid flowing within cooling conduits 27, 29. Alignment of the fluid flow within conduits 47, 75 via alignment valve 45 may be made with reference to a flow direction meter 77. Meter 77 may be a visual and/or electronic meter indicating flow direction of fluid within conduit 75.

In a bypass mode of operation, used fluid from hose 5 flows from meter 77 through conduit 83 to bypass valve 49, through bypass valve 49 and into bypass fluid path 85 and back through valve 49 to line 47, through line 47 to alignment valve 45, through alignment valve 45 to input/output hose 4, and through quick connector 14, through stem 10 and into cooling return line 29 which carries the used fluid back into transmission 9. In bypass mode of operation, the used fluid is recirculated back to the transmission 9 without substantial introduction or exchange of fresh fluid. Bypass mode of operation may take place before, during or after the fluid exchange procedure as described hereinafter. Bypass mode may be entered via mechanical actuation of bypass valve 49. Mechanical actuation of valve 49 may be via operator manipulation or via a float mechanism. One such float mechanism may include a float within fresh fluid reservoir 23 which moves in response to a fluid level. The float may be used to mechanically move bypass valve 49 or may provide a signal to an electronic controller which, in response to a float signal, activates the valve 49. Bypass mode may also be entered via electrical actuation of bypass valve 49 in response to other signals, such as start flow or stop flow control signals.

Flow alignment valve 45 may be controlled in response to the direction of flow indicated at meter 77. In the illustrated embodiments, flow alignment valve 45 is a two position flow direction selector valve which switches direction of flow between lines connecting valve 45 and bypass valve 49, thus providing the capability to randomly connect the input/outlet hoses 4, 5 to either side of opened cooling circuit 27/11/29. Alignment valve 45 permits quick alignment of the direction of flow in cooling circuit 27/11/29 with the direction of flow in the two main subsystems, the used fluid extraction subsystem and the fresh fluid introduction subsystem which are contained in the fluid exchange system 20. In the embodiment illustrated in FIG. 2, valves 45 and valve 49 are mechanically operated. In other embodiments valves 45, 49 may be electrically operated, microprocessor controlled, and/or electronically indicating.

Valves 45, 49 as depicted in FIG. 2 are illustrated in most basic form for simplicity of illustration. Various other more dispersed variants comprised of multiple solenoid or manually operated sub-units can be utilized which operate under the same principle of art when examined in unity, but do not vary from the actual scope of what is illustrated in this embodiment.

If the used fluid is flowing through cooling circuit 27/11/29 such that when randomly connected to the invention with valve 49 in its Off/bypass mode (dotted line) meter 77 indicates that the flow is not in alignment with the invention. Flow alignment valve 45 may then be actuated to its second, alternate position which institutes a flow alignment condition which is then indicated at meter 77.

Meter 77 electronically and/or visually indicates proper flow alignment, and may also indicate the rate of flow at which the used fluid is being circulated through cooling circuit 27/11/29 as bypassed through bypass fluid path 85 and the operator makes note of this.

When bypass valve 49 is in its Off/bypass position (as indicated by dotted lines), the used fluid passes only through the valve ports connected to both sides of bypass fluid path 85. At this point, the operator may use sample tap 87 to draw a sample of the used fluid circulating in the cooling circuit into a clear sample vial to later give to the vehicle's owner.

In an exchange mode of operation, bypass valve 49 is placed in a secondary or On position (as indicated with solid lines) which allows the fresh fluid forced into line 63 by pump 65 to flow through flow regulator 61 through line 59 to flow meter 57, through line 51 to the main valve 49 to line 47, through line 47 to alignment valve 45, through alignment valve 45 and to input/output hose 4 and then into the return cooling line 29. As the fresh fluid then flows through the fresh fluid introduction subsystem of the invention and into the return side of the opened cooling circuit, it then flows to the internal transmission components downstream to the return side of the cooling circuit and eventually comes to rest in transmission 9. As fresh fluid so flows, the operator (or an electronic controller) adjusts flow regulator 61 such that the rate of flow of fresh fluid approximately matches the flow rate at which used fluid was measured at meter 77 to have been circulating at in the cooling circuit when the invention was in bypass mode with the transmission operating in park. After so operating the invention for a period of time necessary to exchange the contents of the transmission system, the operator may activate bypass valve 49 by moving its selector to the alternate Off/bypass position. At this point, pump 65 may still be activated but not delivering fresh fluid into transmission 9 because main valve 49 now has closed fresh fluid delivery line 51. The operator can examine the volume indicating marks on fresh receptacle 23 which will indicate the amount fresh fluid was used in the exchange procedure.

Input/output hoses 4, 5 can then be disconnected at quick connectors 14, 16. Stems 10, 12 can then disconnected from both sides of the opened cooling circuit at port 28 and connection 30. Cooling return line 29 is then reconnected to port 28 at connection 30 to close the previously opened cooling system 27/11/29.

The vehicle is now started with the transmission in park and the operator checks the cooling circuit for any leaks should the connections not be secure. The operator then checks the fluid level of the transmission by use of the dipstick (not shown) inserted in dipstick/filler tube.

In other embodiments of the exchange system 20, a microprocessor can be used to control valves 45, 49 and other system controls. The microprocessor may receive electronic indicating signals from electronically indicating sensors and meters, the process the signals according to software instructions and then elicit electronic command signals to individual components which are electronically controlled and electrically powered. The selection of a specific wiring harness, microprocessor parts, circuits and connectors, etc. would be within the skill of a person of ordinary skill in the relevant art.

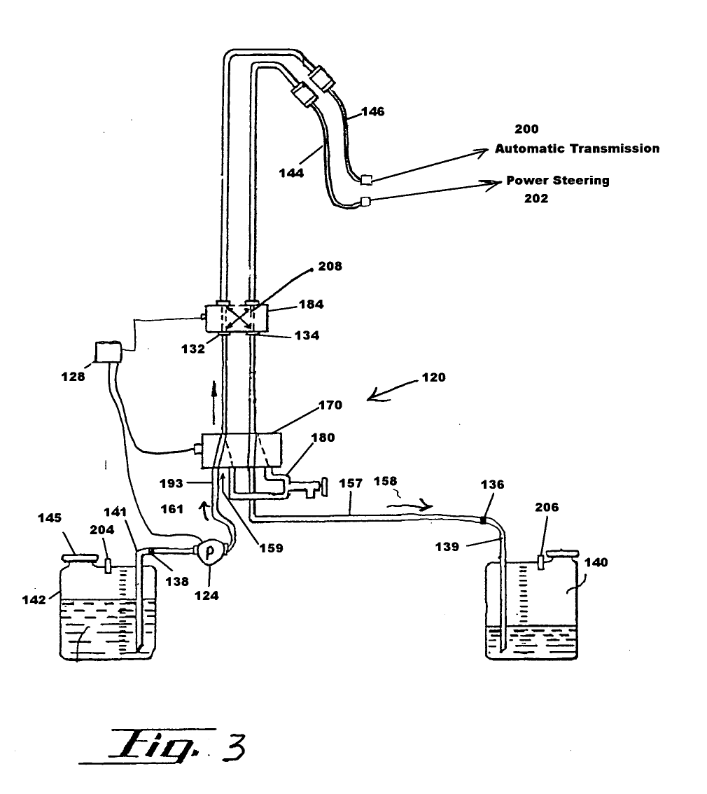

Referring now to FIG. 3, another embodiment of an automotive fluid servicing apparatus, generally designated 120, incorporating aspects of the present invention is illustrated. In general, such fluid servicing apparatus is incorporated into a convenient, portable wheeled cabinet housing a plumbing subsystem and an electrical command subsystem cooperating to drain fluid from a serviceable component, add fluid to the serviceable component, circulate fluid between the serviceable component and the apparatus, and drain collected or other stored fluid using a single, common pump 124 and an integrated conduit system as directed by a service technician and controlled by a processor/controller 128.

System 120 includes an exhaust port 132, a return port 134, a drain port 136, and a fresh fluid supply port 138. Each port may be threaded for coupling with one end of a respective conduit, hose, or other suitable tubing or piping, which are in turn connected to a desired source or destination. For ease of assembly, it is preferable to thread one portion of each hose coupling into the respective threaded port opening. The threaded coupling component is constructed to allow the assembler to merely press the free end of the selected conduit into the complementary coupling component threaded into the port.

A used fluid conduit 139 connects between the drain port 136 and a used fluid collection tank 140 to carry fluid therebetween. Similarly, the fresh fluid supply port 138 connects via a new fluid supply conduit 141 to a new fluid tank 142. Such used fluid collection tank 140 is constructed to hold a sufficient amount of used fluid to accommodate at least complete drain procedure and preferably more. The new fluid tank 142 is typically constructed to hold a sufficient volume of fresh fluid to accommodate a single fill procedure and preferably has a greater capacity as well. This fresh fluid source 142 may be filled through a fill hole 145. As it is preferred that the servicing apparatus maintain a portable capability, the used and new fluid tanks are preferably mounted inside the cabinet which is sized to accommodate the preferred tank capacities.

Further convenience is provided by a set of servicing hoses, 144 and 146 respectively for connecting between the return port 134 and the exhaust port 132 of the servicing apparatus 120 and the influent line and effluent line of the serviceable component such as an automatic transmission or power steering unit of an automobile. The use of conventional adapters is also contemplated if necessary. The connectors illustrated in FIG. 3 are exemplary and not meant to be limiting in any manner as other suitable connectors will occur to one of ordinary skill. Such connection places the transmission or power steering system in fluid communication with the servicing apparatus 120 as will be discussed below.

A number of pathways are defined within system 120 as well as a number of flow control components for routing fluid entering and exiting the system between the various fluid ports 132, 134, 136, and 138. In this exemplary embodiment, there are at least three such pathways including a drain path, generally designated 157, for flow of fluid as indicated by directional arrow 158, a recirculation path, generally designated 180, for flow of fluid as indicated by directional arrow 159, and a supply path, generally designated 193, for fluid flow as indicated by directional arrow 161. Each pathway 157, 180, and 193 include couplings or connectors of flexible or rigid material connected to one or more manifold ports.

During a fluid exchange procedure as will be discussed below, fluid is normally directed in the direction of arrow 158 through the drain path 157 from the return port 134 to the used fluid drain port 136 which may be connected to the used fluid collection tank 140 via conduit 139. Valve 170 includes a exchange position which directs fluid entering the inlet of the valve 170 out of a drain outlet of the valve 170 and through the remainder of the drain path 158 and a bypass position which directs fluid entering the inlet of the valve 170 out of an alternate outlet and through a recirculation path 180.

When the drain/bypass valve 170 is energized to the bypass position, the recirculation path 180 is opened and the drain path 157 is blocked. Fluid entering the recirculation path from the return port 134 is directed through the valve 170 set in the bypass position 168 to exhaust port 132. Such recirculation path normally serves to circulate fluid in the direction indicated by arrow 159 between the serviceable component and the servicing apparatus while bypassing the pump 124, used fluid tank 140, and new fluid tank 142.

With continued reference to FIG. 3, fluid typically enters the return port 134 from conduit 144 connected to the downstream port of the transmission and exits the exhaust port 132 to be directed through hose 146 to the upstream port of the transmission 200 or power steering circuit 202. Fluid is generally circulated through the fluid circuit by the pump 124. Direction of the fluid through the fluid circuit is normally determined by the respective positions of the drain/bypass valve 70 and the flow alignment valve 184. The drain/bypass valve 170 operates to direct fluid entering the return port 134 through the drain or bypass passages 157 and 180 respectively with one side of the valve 170 in fluid communication with the return port 134 and the second side in fluid communication with the drain port 136 and exhaust port 134. When valve 170 enters into the drain position the bypass passage 180 is blocked off and the passage between the return port 134 and the drain port 136 is open and fluid may flow in the direction of arrow 158. On the other hand, when the valve 170 is energized to the bypass position, the drain passage 157 is blocked off and the passage between the return port 134 and the exhaust port 132 is open establishing a bypass loop 180 wherein fluid may circulate in the direction of the arrow 159 and wherein fluid does not circulate through the pump 124.

The heart of the electrical command sub-system is the controller 128 which is a programmable circuit board having a central processing unit (CPU) and associated memory for transmitting control commands to the pump 124 or valves 170, 184 in accordance with command sequences stored in the memory responsive to feedback transmitted from a number of sensors to direct the fluid service operations selected by a service technician.

The controller 128 is connected to a new fluid tank sensor 204 and a used fluid tank sensor 206 through their respective electrical leads to provide fluid level feedback for each tank, 142 and 140, respectively. The fluid level sensors detect the fluid level in their respective fluid tanks and provide this information to the controller.

The pump 124, drain/bypass valve 170, and flow alignment valve 184 are in electrical communication with the controller 128 via their respective electrical connectors. Using feedback from the sensors and any additional operator input, the controller energizes the bypass and flow alignment valves 170 and 184 to the desired positions as will be described below and further actuates the pump 124 to on and off states during selected servicing procedures to circulate the fluid through the fluid circuit from the desired source to the selected destination.

When the service technician is prepared to service an automobile transmission, with reference to FIG. 3, the new fluid tank 142 and used fluid tank 140 may initially be empty. The servicing apparatus 120 is initially prepped for servicing by filling a quantity of new transmission fluid through a fill hole (not shown) into the new fluid tank 142. For purposes of this operational procedure, it will be assumed that the used fluid tank 140 is initially empty and the new tank 142 has an adequate supply of transmission fluid to perform a complete exchange. The servicing apparatus 120 is wheeled over near the transmission to be serviced. Using well known procedures, the service technician interrupts the transmission cooling lines to expose an influent line or inlet port and an effluent line or outlet port and connects the free ends to the return and exhaust ports 134 and 132 using the service hoses 144 and 146 using conventional adapters if necessary. Preferably, the technician connects the effluent line of the transmission to the return port 134 and further connects the influent line at one end to the exhaust port 132 such that the connection places the transmission in fluid communication with the fluid passages 157, 180 and 193 of the servicing apparatus 120. If through inadvertence or error the technician connects the effluent line of the transmission to the exhaust port 132 and further connects the influent line at one end to the return port 134, the flow alignment valve 184 may be selectively activated to correct the alignment of flows within the apparatus 120. It will be appreciated that the service hoses 44, 46 may be clear allowing an operator to visually check the condition of the fluid in each hose. The default position of the drain/bypass valve 170 is the bypass position blocking off the drain path 157 so that fluid flow from the transmission will circulate through fluid passage 180 in the direction of arrow 159 initially when the vehicle engine is turned on to activate the transmission pump.

Using the versatile servicing apparatus 120, the technician may perform several servicing procedures including circulation and clean, automatic transmission fluid exchange by draining and refilling the transmission in incremental steps, draining and refilling the transmission pan, topping off fluid levels, and draining the new and used fluid tanks. It will be appreciated that the following procedures are performed using a pump 124 operating in conjunction with the vehicle transmission pump for some procedures.

The operator may start the vehicle engine to operate the transmission pump and to pressurize fluid out of the transmission to begin circulating fluid through recirculation passage 180. This is commonly referred to as bypass or recirculation mode. Depending on the transmission pump and direction of fluid flow, used fluid from the transmission is forced out into either the return port 134 or the exhaust port 132. Fluid will either flow in the direction of arrow 159 or in a reverse direction. The fluid exits the recirculation passage 180 from the opposite port wherein fluid is entering and reenters the transmission through the associated servicing hose. At this point a closed circulation loop between the vehicle transmission cooling lines and servicing apparatus 120 is established.

The operator presses the start button on the control panel of the servicing apparatus 120, which causes several actions to occur. Initially, the controller 128 energizes the drain/bypass valve 170 to move from the bypass position to the drain position to block off the recirculation passage 180 and open the drain path 157. If the service hoses have been connected so as to provide flow alignment between the system 120 and the accessed fluid circuit, used fluid entering the return port 134 under pressure from the transmission pump is directed through the drain path 157, along the direction of arrow 158, through the drain port 136 and used fluid conduit 139 connected thereto to be collected in the used fluid collection tank 140. If the service hoses have been connected in an opposite manner, flow alignment valve 184 may be activated to correct fluid flow within the system 120.

When the start button is pressed the transmission pump will force the fluid from the return port 134 into the drain passage 157 and through the valve 70 set in the drain position. Used fluid passing through the valve 170 is directed to the drain port 136 in the direction of arrow 158 and expelled into the used fluid tank 140.

While such features have been provided in the servicing apparatus 120 to minimize operator intervention and facilitate maintenance of the servicing apparatus and alert the operator to error conditions, as discussed above, it is contemplated that an operator may on occasion inadvertently couple the service hoses 144 and 146 between the transmission and servicing apparatus 120 incorrectly thus creating a reverse fluid circulation condition.

An exemplary embodiment of the present invention includes a flow alignment valve 184 for avoiding the necessity of manually switching the hoses 144 and 146. Flow alignment valve 184 is preferably a 2-position, 4-way valve with cross flow capabilities. The crossflow valve 184 includes a normal fluid exchange position and a cross flow fluid exchange position, indicated by directional arrows 208. Thus, it will be appreciated that such valve 170 enables the operator to connect the hoses 144 and 146 without concern as to the flow direction as determined by the transmission configuration. Once the controller 128 establishes the proper valve position, all servicing procedures may be performed as described above.

When energized to the normal fluid exchange position by the processor 128, used fluid entering the return port 134 is transferred to the used fluid tank 140 and new fluid withdrawn from the new fluid tank 142 may be transferred to the exhaust port 132 in a manner similar to that described above in the first embodiment.

While the above described embodiments serve particularly well in servicing automatic transmissions, the present invention further contemplates servicing other automobile fluid systems as well and provides such convenience in a single portable wheeled apparatus. For example, when an automobile is taken in for transmission servicing, it is typically desirable and convenient to exchange the power steering fluid at the same time. The fluid exchange systems of the present invention may be advantageously utilized to service both automatic transmission and power steering systems of an automobile.

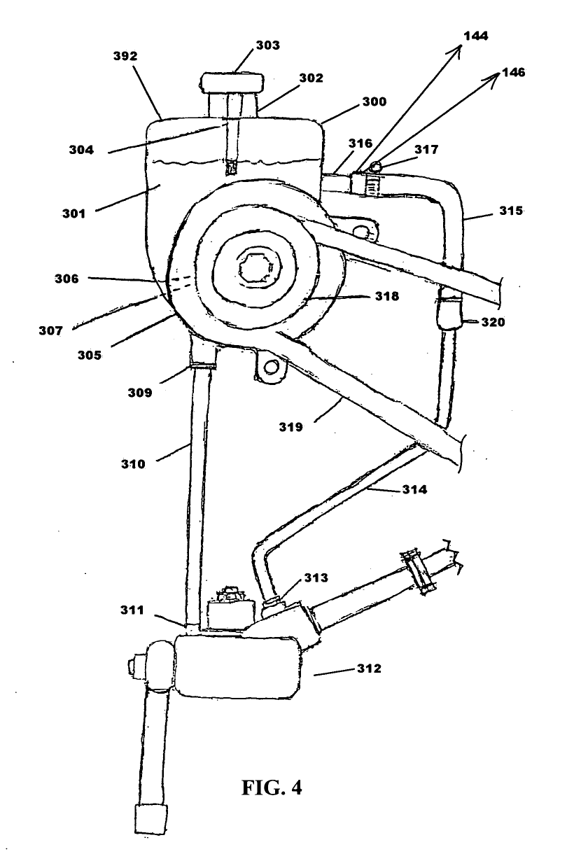

FIG. 4 depicts one of the two basic types of power steering systems found in vehicles today, commonly referred to as a traditionally configured power steering system which has its fluid reservoir arranged integral to the power steering pump as a reservoir-pump combination assembly. With this configuration the pump supply conduit from the reservoir to the intake port of the pump is very short in length and is hidden from view inside the reservoir-pump combination assembly. Typically a power assisted steering gear mechanism accompanies this configuration. The power steering system of FIG.4 has a reservoir 300 arranged integral to a power steering pump 305 to form a combination reservoir-pump assembly 392. Reservoir 300 contains a fluid 301. A reservoir outlet conduit 306 carries fluid 301 from reservoir 300 to an inlet port 307 of pump 305. Typically, this configuration includes a steering gear mechanism 312. A pressure conduit 310 connects an outlet port 309 of pump 305 to an inlet port 311 of steering gear mechanism 312, which is power assisted by the pressurized fluid provided by pump 305 through pressure conduit 310. The fluid in pressure conduit 310 has higher pressure than the fluid located anywhere else in the power steering system and this pressurized fluid is the working fluid which provides the power to assist the driver in steering the vehicle. Thus fluid 301 is pressurized by pump 305 to provide power to do the hydraulic work required to make the vehicle easier to steer by the driver. Steering gear mechanism 312 has a fluid return conduit 314 with hose end 315 attached by a ferrule 320 which may be crimped. Fluid return conduit 314 is connected to an outlet port 313 of steering gear mechanism 312. Hose end 315 is connected to a reservoir return port 316 and sealingly secured by a hose clamp 317, which is a stainless steel gear drive type. Power is provided to pump 305 by a belt 319 which is rotated around a pulley 318 under power of the engine of the vehicle (not shown). Reservoir 300 has a filler neck 302 which receives and holds a cap 303 which is vented to the atmosphere. Cap 303 has a dipstick 304 integral to its bottom side. Fluid 301 is delivered from reservoir 300 under power of pump 305 to be circulated out of port 309 through pressure conduit 310 into port 311, through steering gear mechanism 312, out of outlet port 313, through conduit 314 and hose 315, into and through port 316 to be deposited back into reservoir 300 for redundant delivery and circulation by pump 305.

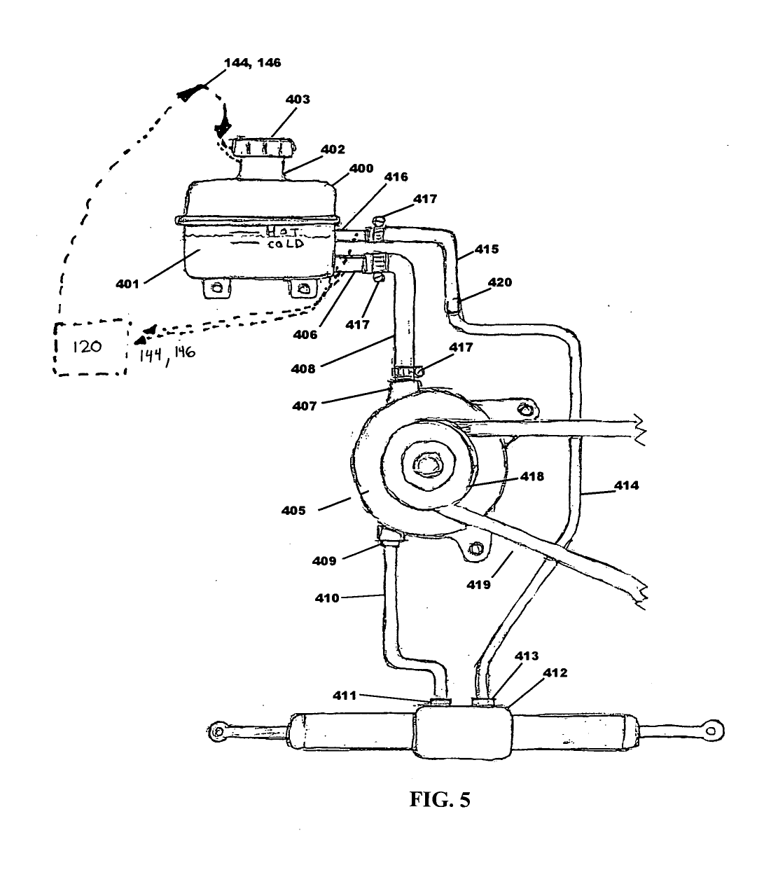

FIG. 5 depicts the second of two basic types of power steering systems found in vehicles today, commonly referred to as a more modern power steering system which has its fluid reservoir arranged at a remote location above the power steering pump with the pump supply conduit and the low pressure outlet conduit from the power assisted steering mechanism typically visible and accessible, with each conduit connected to one of the two ports of the remote reservoir. A power assisted rack and pinion steering mechanism typically accompanies this second type of system. As with the more traditionally configured system having a reservoir-pump combination, the low pressure fluid return conduit from the power assisted steering mechanism is connected to the return port of the reservoir. In addition the fluid reservoir is typically translucent, allowing one to note the fluid level through the wall of the reservoir at designated marks on the wall. This power steering system has a fluid reservoir 400 arranged at a remote location above a power steering pump 405 which contains a fluid 401. Reservoir 400 has two visible and typically accessible ports, a reservoir outlet port 406 and a reservoir return port 416. A pump supply hose 408 connects reservoir outlet port 406 to a pump inlet port 407. Pump supply hose 408 is sealingly secured to port 406 and to port 407 by a pair of hose clamp 417. A pressure conduit 410 connects a pump outlet port 409 of pump 405 to an inlet port 411 of a rack and pinion steering mechanism 412, which is power assisted by the fluid power provided by pump 405. Fluid 401 is pressurized by pump 405 to provide power to do the hydraulic work required to make the vehicle easier to steer by the driver. Rack and pinion steering mechanism 412 has a fluid return conduit 414 with a hose end 415 attached by a ferrule 420 which may be crimped. Fluid return conduit 414 is connected to an outlet port 413 of rack and pinion steering mechanism 412. Hose end 415 is connected to reservoir return port 416 and sealingly secured by hose clamp 417. Power is provided to pump 405 by a belt 419 which is rotated around a pulley 418 under power of the engine of the vehicle (not shown). Reservoir 400 has a filler neck 402 which receives and holds a cap 403 which is vented to the atmosphere. In normal operation the power steering system is constructed and arranged for fluid 401 to be delivered from reservoir 400 through port 406, through pump supply hose 408 into pump inlet port 407 under power of pump 405 to be circulated out of pump outlet port 409 into and through pressure conduit 410 and through inlet port 411, through rack and pinion steering assembly 412, out of outlet port 413, through fluid return conduit 414 and hose end 415, and into and through reservoir return port 416 to be deposited into reservoir 400 for redundant delivery and circulation by pump 405.

The automotive fluid servicing apparatus of the present invention may be utilized to exchange power steering fluid of a vehicle. For example, the fresh fluid tank 142 may hold fresh power steering fluid and the used fluid tank 140 may receive used fluid during an exchange procedure. In a manner similar to the transmission exchange procedure, the service hoses 144, 146 may be intercoupled into a power steering fluid circuit. For example, and with reference to FIG. 5, service hoses 144, 146 may be coupled to pump supply hose 408 and fluid return conduit 414. Alternatively, one of the service hoses 144, 146 may simply be inserted into the fluid reservoir 400 so that fresh power steering fluid freely flows from the hose 144, 146 into the reservoir 400. In such an application, the reservoir return port 416 may be capped to prevent fluid flow. Additional access locations may exist within the power steering circuit which permit introduction of the power steering servicing apparatus 120. The features of flow alignment and/or bypass may also find practical use in a power steering servicing apparatus according to the present invention. For example, a flow alignment valve may be utilized to change the flow of fluid with the exchange system to correct for inadvertent misconnection of the fluid exchange system into the power steering hydraulic circuit. Additionally, a bypass valve may be utilized to isolate portions of the fluid exchange system during periods of the overall exchange process.

While my above description contains many specifics, these should not be construed as limitations on the scope of the invention, but rather as exemplification of two embodiments thereof. For example, there are many similar ways to illustrate certain of the device's valve and indicator functions as numerous single entity components organized in more complex fashion while functioning in the same overall manner as illustraed in my figures and described in my specifications. These variants should not be construed as significantly different from the novel art presented in my specifications or claims byt should be consudered as a part of this same novel art my device is based on. These many possible small changes and alternative methods to express the same principles of the novel art of my device are not important enough to illustrate in the drawings. Accordingly, the scope of the invention should be determined not by the embodiments illustrated, but by the appended claims and their legal equivalents.

1. A fluid exchange system comprising:
a first fluid line selectively intercoupled to the fluid exchange system and one of a pair of fluid circuit ports to conduct fluid from a fluid circuit of a vehicle;
a second fluid line selectively intercoupled to the fluid exchange system, a source of fresh fluid, and the other one of the pair of fluid circuit ports to conduct fluid into the fluid circuit of the vehicle;
a bypass fluid path in selective fluid communication with the pair of fluid circuit ports;
a bypass valve assembly in communication with the bypass fluid path, said fluid exchange system having a pair of operational conditions including: a first operational condition wherein used fluid is passed through the bypass fluid path and reintroduced into the fluid circuit of the vehicle, and a second operational condition wherein used fluid is received into the first fluid line and fresh fluid is received into the second fluid line and introduced into the fluid circuit of the vehicle; and
at least one electrically operated valve for controlling fluid flow through the bypass fluid path.

2. The fluid exchange system of claim 1 further comprising:
a flow alignment valve assembly coupled to the first and second fluid lines to reverse a fluid flow within the exchange system.

3. The fluid exchange system of claim 1 further comprising:
a portable chassis containing a source of fresh fluid.

4. The fluid exchange system of claim 3 further comprising:
a portable chassis containing a receptacle for used fluid.

5. The fluid exchange system of claim 1 wherein the fluid circuit of the vehicle is a transmission cooling circuit which circulates transmission fluid therewithin.

6. The fluid exchange system of claim 1 wherein the fluid circuit of the vehicle is a power steering fluid circuit and the pump is a power steering pump of the vehicle which circulates power steering fluid within the power steering fluid circuit.

7. A fluid exchange system comprising:
a first fluid line selectively intercoupled to the fluid exchange system and one of a pair of fluid circuit ports to conduct fluid from a fluid circuit of a vehicle;
a second fluid line selectively intercoupled to the fluid exchange system, a source of fresh fluid, and the other one of the pair of fluid circuit ports to conduct fluid into the fluid circuit of the vehicle;
a bypass fluid path in selective fluid communication with the pair of fluid circuit ports;
a bypass valve assembly in communication with the bypass fluid path, said fluid exchange system having a pair of operational conditions including: a first operational condition wherein used fluid is passed through the bypass fluid path and reintroduced into the fluid circuit of the vehicle, and a second operational condition wherein used fluid is received into the first fluid line and fresh fluid is received into the second fluid line and introduced into the fluid circuit of the vehicle; and
at least one manually actuatable valve for controlling fluid flow through the bypass fluid path.

8. The fluid exchange system of claim 7 further comprising:
a flow alignment valve assembly coupled to the first and second fluid lines to reverse a fluid flow within the exchange system.

9. The fluid exchange system of claim 8 further comprising:
a portable chassis containing a source of fresh fluid.

10. The fluid exchange system of claim 9 further comprising:
a portable chassis containing a receptacle for used fluid.

11. The fluid exchange system of claim 7 wherein the fluid circuit of the vehicle is a transmission cooling circuit which circulates transmission fluid therewithin.

12. The fluid exchange system of claim 7 wherein the fluid circuit of the vehicle is a power steering fluid circuit which circulates power steering fluid therewithin via a power steering pump.

13. A method for exchanging a used fluid with a fresh fluid in a fluid circuit of the vehicle, with the used fluid circulated through the fluid circuit under power of a pump, said method comprising the steps of:
providing a portable fluid exchange system having a first conduit for communicating fluid from the fluid circuit of the vehicle, a second conduit for communicating fluid to the fluid circuit, and a bypass fluid path having a bypass valve for selectively communicating fluid between the first conduit and the second conduit;
coupling the first and second conduits of the fluid exchange system into the fluid circuit of the vehicle;
operating the vehicle with the system being in a fluid exchange condition wherein used fluid from the fluid circuit is received into the first conduit and fresh fluid is received into the second conduit and introduced into the fluid circuit;
establishing a bypass condition by electrically actuating the bypass valve so that used fluid from the fluid circuit is passed through the bypass conduit and into the second conduit whereby used fluid is reintroduced into the fluid circuit; and
operating the vehicle with the system being in the bypass condition.

14. A method for exchanging a used fluid with a fresh fluid in a fluid circuit of the vehicle, with the used fluid circulated through the fluid circuit under power of a pump, said method comprising the steps of:
providing a portable fluid exchange system having a first conduit for communicating fluid from the fluid circuit of the vehicle, a second conduit for communicating fluid to the fluid circuit, and a bypass fluid path having a bypass valve for selectively communicating fluid between the first conduit and the second conduit;
coupling the first and second conduits of the fluid exchange system into the fluid circuit of the vehicle;
establishing a bypass condition by electrically actuating the bypass valve so that used fluid from the fluid circuit is passed through the bypass fluid path and into the second conduit whereby used fluid is reintroduced into the fluid circuit;
operating the vehicle with the system being in the bypass condition;
establishing a fluid exchange condition by electrically actuating the bypass valve so that used fluid is prevented from passing through the bypass fluid path; and
operating the vehicle with the system being in a fluid exchange condition wherein used fluid from the fluid circuit is received into the first conduit and fresh fluid is received into the second conduit and introduced into the fluid circuit.

15. A fluid exchange system for performing a fluid exchange procedure on a vehicle having a fluid circuit, said fluid exchange system comprising:
a flexible first conduit for communicating fluid from the fluid circuit of the vehicle;
a flexible second conduit for communicating fluid to the fluid circuit of the vehicle;
a bypass fluid path between the first conduit and the second conduit; and
a bypass valve, wherein a bypass mode of operation is established after manually or electrically actuating the bypass valve so that used fluid from the fluid circuit is passed through the bypass fluid path and reintroduced into the fluid circuit, and wherein an exchange mode of operation is subsequently or previously established when the bypass valve is manually or electrically actuated and used fluid from the fluid circuit is received into the first conduit and fresh fluid is received into the second conduit and introduced into the fluid circuit.

16. The fluid exchange system of claim 15 wherein the first and second conduits are connected to a transmission cooling circuit of the vehicle.

17. The fluid exchange system of claim 16 wherein the first and second conduits are connected to a power steering circuit of the vehicle.

18. The fluid exchange system of claim 16 further comprising a flow alignment valve assembly in fluid communication with the first and second conduits.

19. The fluid exchange system of claim 16 further comprising a float mechanism within a fresh fluid tank to control the flow of fresh fluid into an accessed fluid circuit.
